(19) United States
(12) Patent Application Publication
(10) Pub. No.: US 2026/0309120 A1
(43) Pub. Date: Oct. 8, 2026

(54) CONSTRUCTION FOR CASCADE HYDRO POWER PLANT

(71) Applicant: Tomislav TESLA, Kac-Novi Sad (RS)

(72) Inventor: Tomislav TESLA, Kac-Novi Sad (RS)

(21) Appl. No.: 19/483,343

(22) PCT Filed: May 9, 2024
(86) PCT No.: PCT/RS2024/000007

§ 371 Date: Nov. 11, 2025

(30) Foreign Application Priority Data
May 11, 2023 (RS) P-2023/0357

(51) Int. Cl. F03B 17/06

(52) U.S. Cl. CPC F03B 17/06

(57) ABSTRACT

The construction for the installation of the Cascading Hydroelectric Power Plant in the very bed of the river was solved as follows: A base plate (6) is provided, on which the sill (7) is built. On both sides, a wall (4) is placed on the plate (6) and the threshold (7) for the fixed position of the Hydro Wing (8) and the arch (9) with the grid (10). This is how the difference in the height (17) of the water with the position of the Hydro Wing (8), under which the water (2) flows for the needs of the operation of the blades (15) of the turbine, is formed.

The blades (15) of the turbine rotate around the Hydro Wings (8), arranged by the position of chains (29), guides (30) and rollers (31). The chain (29) rotates with the paddles (15) at the position of the sprocket (28) with the housings. Sensors (25) monitor the water level when the Hydro Turbine is automatically started or stopped with the help of the described assembly, when the vane (15) also serves as a valve (24) to stop the water flow. Everything needed for the production of electricity.

### TECHNICAL FIELD

The construction enables efficient exploitation of the hydro potential of lowland rivers with the corrected construction of Rotating Hydro Turbines, in order to use the small difference in the slowness of the water in the river bed, as well as the action of the sea current for the production of electricity. With a simple and efficient construction, we protect the banks of the river from flooding, the living environment is improved, the navigability of the river is guaranteed. The flow of water in the river can be stopped at night, and for the daily needs of electricity production, which has not been technically possible in the river basin up to its mouth.

### Technical Problem

Existing technical solutions are useful, but considerable material resources are spent for their application and they are complicated to maintain. The idea presented here is an extension of Patent WO 2019/103634 A2. With the new construction solution, there is a technical possibility to significantly reduce the number of turbine blades, as well as the simplicity of construction with reinforced concrete construction, templated. The barrier and valve setting has been reduced, the engine room is located below the water level, only the reinforced concrete arch can be seen.

### BACKGROUND ART

The current technology of using sea currents is insufficiently developed, as well as the economics of building Cascade Hydroelectric Power Plants in the river, which is described with the application of technology in Patent WO 2019/103634 A2. The solutions presented here build on the existing patent with simplicity of construction, the technology is being developed for real commercial application, which is described below.

### DISCLOSURE OF INVENTION

By placing a reinforced concrete slab as a foundation in the riverbed, with the elevated position of the threshold, the entry and exit of water into the turbine pipe is concentrated. The turbine pipe is formed with a horizontal position of the sill and the lower surface of the Hydro Wing, with a vertically placed retaining wall on both sides. The Hydro Wing is the height of the water stagnation, on its top there is an overflow for water, while six to eight blades rotate around it. An arch is placed above the hydrofoil that protects the rotation of the blades, over which high water and flood waves occasionally pass when it comes to the flow of the river. The grid located on the upstream side of the Hydroelectric Power Plant, which is connected to the foundation plate and arch, is a safe technical solution for the operation of the Hydroelectric Power Plant until the moment of discharge of the used water in the downstream part of the river.

### BRIEF DESCRIPTION OF DRAWINGS

The desired form of the invention will be described in the attached sketches that can explain the principle of using the construction. The invention will not be limited to the technical model shown here that describes the possibility of setting up a Hydroelectric Power Plant, where the pictures shown illustrate:

FIG. 1. View of the cross-section of the construction of the Cascade Hydroelectric Power Plant and the location of the threshold, Hydro Wing and arch, in order to ensure the stable position of the Rotating Hydro Turbine, all shown by the position of the elements in accordance with the invention;

FIG. 2. View of the cross-section of the Hydroelectric Power Plant at the place of installation of the chain that rotates with blades around the Hydro Wing, where their operation is enabled by the position of the sprockets and chain guides with housings, rollers with the elements shown, everything necessary to enable easy and smooth rotation of the blades that produce mechanical energy;

FIG. 3. View of part of the Hydro Wing and the engine room installation site that are connected to each other by the position of the retaining wall, where their position groups the elements and assemblies to safely generate electricity below the water level. A part of the possible solution for water entering the grid is shown, as well as the changing position of the barrier;

FIG. 4. View of the longitudinal and cross-section of the turbine pipe, at the location of the turbine blades when they collect the potential energy of the water flow and, with the help of chains, transmit it as mechanical energy, where their movement is shown in the direction of the water flow;

FIG. 5. View from above of the location of the elements arranged in the river bed, in order to ensure the smooth operation of the Cascade Hydroelectric Power Plant with barriers and locks, with additional content and a presentation of possible sports and tourist activities on the river bank.

### BEST MODE FOR CARRYING OUT OF THE INVENTION

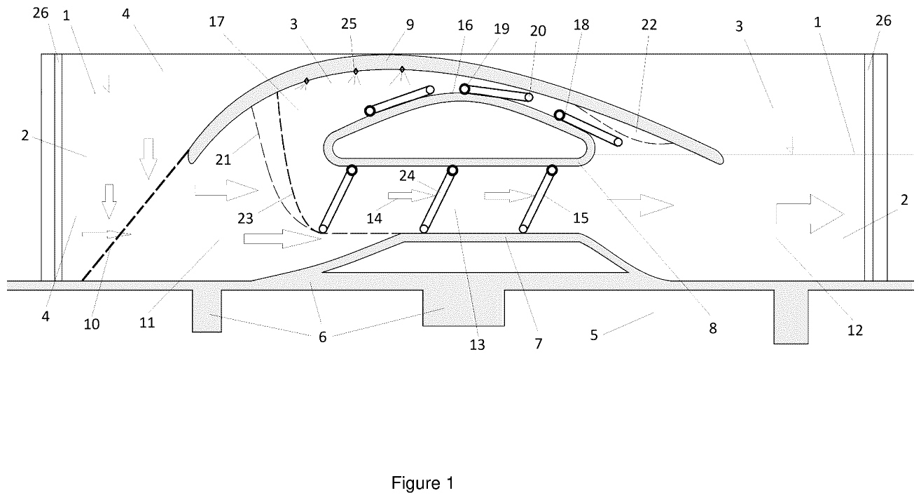

FIG. 1. A view of the cross-section of the construction of the Cascade Hydroelectric Power Plant and the location of the threshold (pos. 7), Hydro Wing (pos. 8) and port (pos. 9) is shown in order to ensure a stable operating position of the Rotating Hydro Turbine. The strip foundation with plate (pos. 6) is firmly positioned at the bottom (pos. 5) of the river bed, so it is the basis for setting up the reinforced concrete threshold (pos. 7). Threshold (pos. 7) has its structural cavity filled with stagnant water in order to use less material during its construction.

Above the threshold (pos. 7), a Hydro Wing (pos. 8) is placed in a parallel relationship, which makes the necessary difference in the height (pos. 17) of the water. In the upper position of the Hydro Wing (pos. 8), a place for overflow (pos. 16) of water is provided. The surface of the Hydro Wing (pos. 8) is also the place of rotation of the blades (pos. 15) of the turbine, so that the bearing (pos. 19) of the support moves on its surface. While the bearing (pos. 20) of the position rotates around the Hydro Wing (pos. 8), planned with correction with the help of the buffer (pos. 22), the guide (pos. 21), the position of the band (pos. 23) made of rubber. The rotation of the blades (pos. 15) is enabled on the rotating bearings (pos. 18), which are suspended on a chain. Hydro Wing (pos. 8) has its structural cavity filled with stagnant water, in order to use less material during its construction. With its construction shape and solid connection with the walls (pos. 4), it well receives the pressure forces from the influence of water (pos. 2) from its lower side. Which in this case amounts to, a total of 300 T to 400 T of evenly distributed thrust force on the lower surface of the Hydro Wing (pos. 8).

Above the Hydro Wing (pos. 8) there is an arch (pos. 9), then, together with the grid (pos. 10), a stable position of the hydro turbine is ensured. Above the arch (pos. 9), a place for the passage of high water (pos. 2) is provided, described in more detail in the Patent WO 2019/103634 for the purposes of flood defense. Sensors (pos. 25) with cameras are located on the lower side of the arch (pos. 9) in appropriate positions. In this way, the acoustic operation of the blades (pos. 15) of the turbine under the position of the bow (pos. 9) is ensured, so the sound of operation is almost inaudible. The paddles (pos. 15) move noiselessly in the water, approximately one per second where they are greeted by the stretching of the rubber bands (pos. 23) and the security of the position of the guide (pos. 21).

The listed five elements, plate (pos. 6), sill (pos. 7), Hydro Wing (pos. 8), arch (pos. 9) with grid (pos. 10) are connected to each other laterally in a solid connection by the position of two supporting walls (pos. 4). This is how a structure is formed that makes the necessary difference in height (pos. 17) of the water. This is how the funnel (pos. 11) was formed, which concentrates and directs 100% of the water into the tube (pos. 13) of the turbine. With the flow (pos. 14) of water (pos. 2) through the tube (pos. 13) of the turbine, a constant force is enabled to rotate the blades (pos. 15). The used water (pos. 2) is free to move in the direction of the water outlet (pos. 12).

The supporting walls (pos. 4) have grooves (pos. 26) placed on them, in which the foundations are placed if necessary. Everything necessary for the installation of parts and overhaul of the Hydroelectric Power Plant. The structures are temporarily fixed, then the sealing rubber is inflated laterally, which is firmly attached to the wall (pos. 4) and against the penetration of water (pos. 2). Then, the excess water (pos. 2) is temporarily pumped out for the needs of overhaul.

The different water level (pos. 1) is shown, the position of water (pos. 2) and air (pos. 3). Where the valve (pos. 24) for the flow of water (pos. 2) is actually the working position of the blade (pos. 15) in the tube (pos. 13) of the turbine. In the operation described below, when the operation of the Hydro Turbine is mechanically blocked with the help of the brake and the transmission system. Then the blade (pos. 15) temporarily stops the flow of water (pos. 2) through the pipe (pos. 13) of the turbine.

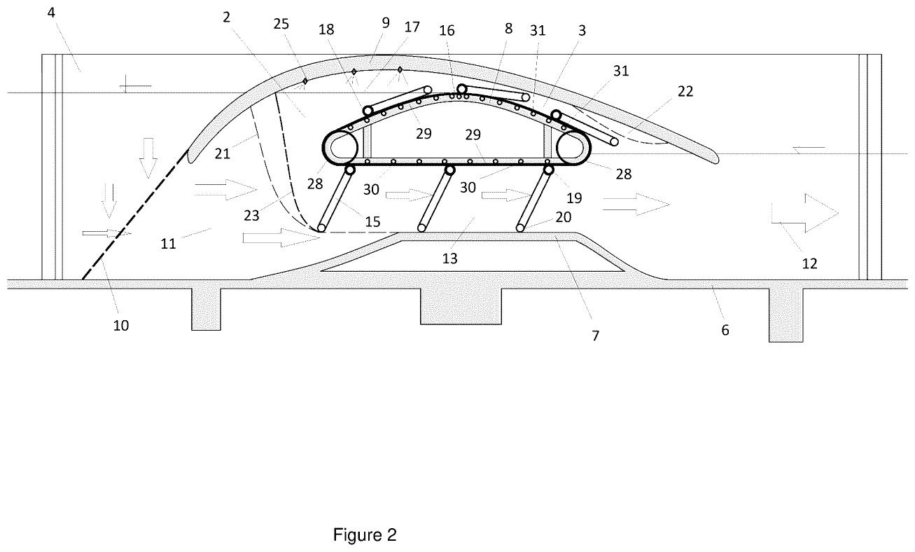

FIG. 2. A view of the cross-section of the Cascade Hydroelectric Power Plant is shown at the place of installation of the multi-row chain (pos. 29) made of stainless steel, which with blades (pos. 15) rotates around the Hydro Wing (pos. 8). The rotation is made possible with the setting of a series of sprockets (pos. 28) in the housings, which are separated from each other on the Hydro Wing (pos. 8). On the lower side of the Hydro Wing (pos. 8), the guides (pos. 30) of the chain (pos. 29) are placed in the housings, which do not allow the blades (pos. 15) of the turbine to move laterally towards the wall (pos. 4), they are centered. While on the upper side of the Hydro Wing (pos. 8) there are rollers (pos. 31) with housings, coated with rubber.

On one side, the blades (pos. 15) of the turbines are partially covered with rubber, in order to safely rest on the multi-row chain (pos. 29), without friction in their return to the initial position. The blades (pos. 15) of the turbine when they pass through the tube (pos. 13) of the turbine take energy from the flow of water (pos. 2), while in their return stroke they move mainly through the air (pos. 3) without resistance. The position of the blades (pos. 15) in the tube (pos. 13) of the turbine is described in more detail in the Patent WO 2019/103634.

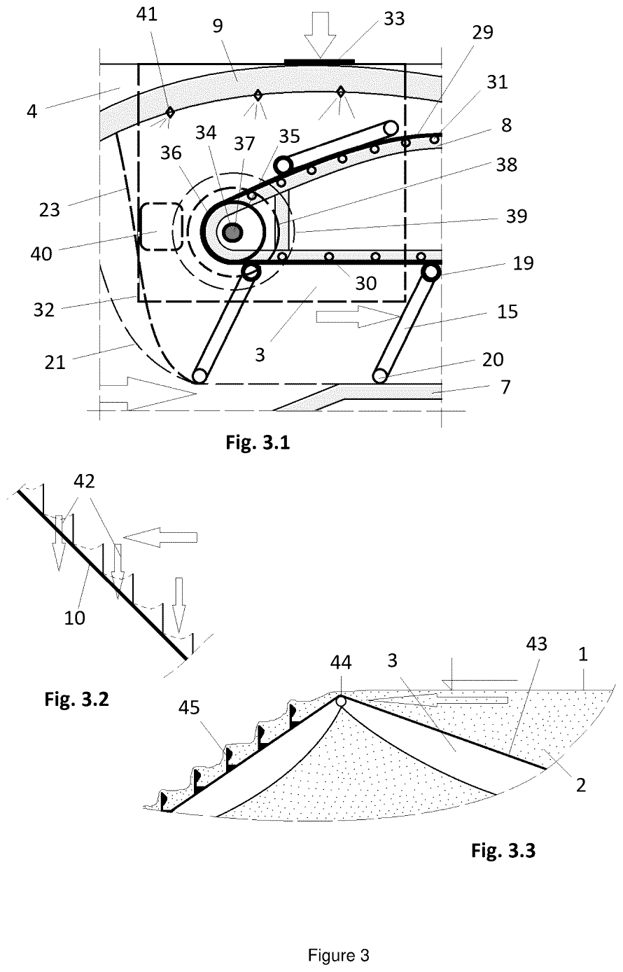

FIG. 3. The view from Fig. is shown. 3.1 to the upstream part of the Hydro Wing (pos. 8) and the location of the machine room (pos. 32) located behind the supporting wall (pos. 4). Where at the point of mutual connection, a searing (pos. 34) is placed, in order to prevent the penetration of water (pos. 2) into the engine room (pos. 32). At the place of the searing (pos. 34), the passage of the drive shaft is provided (pos. 37) through the wall (pos. 4). By the connection position near the Hydro Wing (pos. 8) with the supporting wall (pos. 4), the drive sprocket (pos. 36) is placed in the housing where its main function is to transmit (pos. 35) mechanical energy to the generator (pos. 38) with a reducer via a multi-row chain (pos. 29). Thus, the engine room (pos. 32) is located below the water level, where one entrance and exit is provided at the position of the cover (pos. 33).

In machine room (pos. 32), all the necessary elements and assemblies are located, in order to safely produce electricity. On the lower side of the arch (pos. 9), the water flow regulators (pos. 41) are located, when, among other things, the rise or fall of the water level is observed, all necessary for opening or closing the operation of the Hydro Turbine. In the machine room (pos. 32) at the place of operation of the drive shaft (pos. 37), there is a flywheel (pos. 39) that corrects the operation of the Hydro Turbine and irons the mechanical energy for the needs of stable production of the generator (pos. 38). On the wall of the machine room (pos. 32) there is a brake (pos. 40) which, with the help of automation and the flywheel (pos. 39), is used as braking disc, and through transmission (pos. 35) mechanical energy stops the operation of the Hydro Turbine. Then one blade (pos. 15) with rubber seals blocks the passage of water through the turbine tube.

In FIG. 3.2 shows a part of a possible solution for the vertical inlet (pos. 42) of water through the grate (pos. 10), in order to separate the waste according to the water level. While in FIG. 3.3 shows the position of the barrier (pos. 43) which can be moved up and down with the help of the shaft (pos. 44), explained in more detail in the Patent WO 2019/103634 where the possible setting of the fish ladder (pos. 45) is provided.

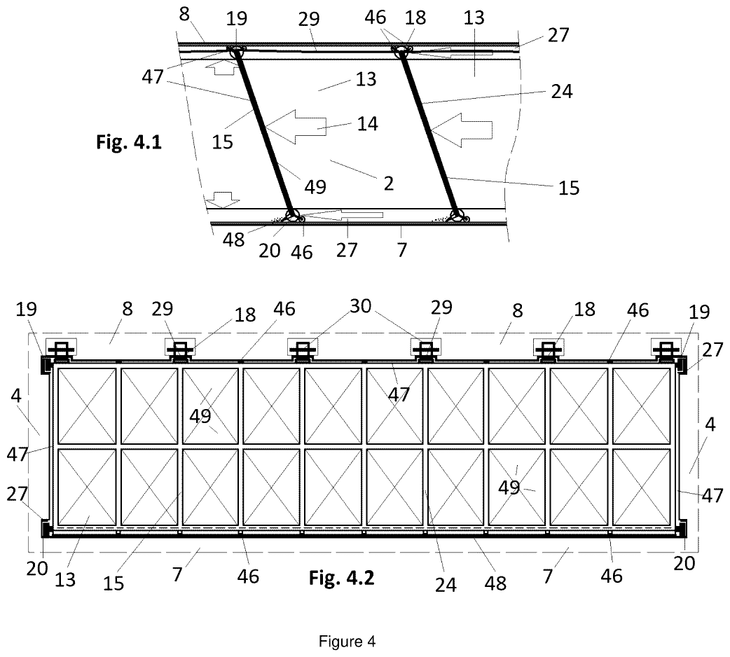

FIG. 4. From FIG. 4.1 shows the longitudinal section of the turbine pipe (pos. 13) with the location of the turbine blades (pos. 15), when the potential energy of the water flow (pos. 2) is collected and with the help of assemblies and chains (pos. 29), the obtained mechanical energy is further transmitted. Where their movement is shown in the direction of water flow (pos. 2). The working position of the blades (pos. 15) with the elements shown is stable when they are supported on the “U” profiles (pos. 27). The operation of the blades (pos. 15) is additionally ensured by the supports of the blade (pos. 15) on the surface of the threshold (pos. 7) and Hydro Wings (pos. 8). (pos. 15) with the wiper (pos. 48) attached, the threshold surface (pos. 7) is regularly maintained from deposits.

In FIG. 4.2 shows the cross-section of the turbine pipe (pos. 13) with the location of the turbine blade (pos. 15) between the two walls (pos. 4), the threshold (pos. 7) and the Hydro Wing (pos. 8). The blade (pos. 15) is supported on four “U” profiles (pos. 27) located in the wall (pos. 4), and at the point of travel two bearings (pos. 19) are supported and two beds (pos. 20) positions. The shovel (pos. 15) does not encroach on the god side with its movement towards the wall (pos. 4), because its movement is centered by the position of the chains (pos. 29) with attached guides (pos. 30) on the lower part of the Hydro Wing (pos. 8). The shovel (pos. 15) is structurally solved with metal profiles that do not allow it to be deformed, it provides additional security a series of attached supports (pos. 46) that roll on the surface of the threshold (pos. 7) and Hydro Wings (pos. 8). The metal profiles are coated with stainless steel sheet (pos. 49), which are punctuated with each other and joined with sheet (pos. 49) on the opposite side of the blade surface (pos. 15).

FIG. 4. Both figures show the location of the blade supports (pos. 46), as well as the location of the sealing rubber (pos. 47) on the blade (pos. 15), which has a role against water penetration (pos. 2) when the blade (pos. 15) has the role of a valve (pos. 24). At the support location (pos. 46) of the blade (pos. 15) on the underside of the Hydro Wing (pos. 8), a groove can be installed, in which additional bearings will move, and in order that the chains (pos. 29) with the upper part of the blade (pos. 15) do not vibrate in their work. Or by designed suspension, when an additional metal “U” profile (pos. 27) is installed in the middle of the lower surface of the Hydro Wing (pos. 8), on which the additional bearing (pos. 19) of the support would then move and which would be attached to the middle of the blade (pos. 15).

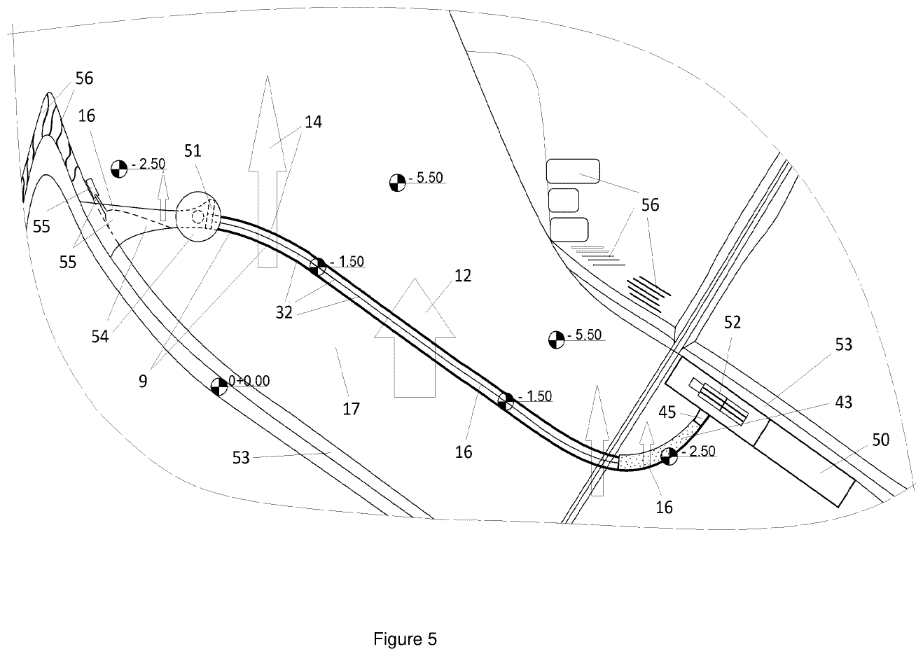

FIG. 5. Shows a view from above of the place of possible application of the innovation, the arranged position of the elements of the “Novi Sad” Cascade Hydroelectric Power Plant, on the Danube River. Where the location of the Hydroelectric Power Plant is mainly at the mother of the river. The Hydroelectric Power Plant is connected from one bank (pos. 53) by a barrier (pos. 43) to a lock (pos. 50), while on the other side a small lock (pos. 51) connects the bank (pos. 53) with a pier (pos. 54) and a lookout point. The Hydropower Plant is placed in the river bed with the shape of the Latin letter “S” in relation to the section of the river section, so that the water flow with the inclined position of the barrier (pos. 43) and the arch (pos. 9) concentrates the waste under pier (pos. 54). Under pier (pos. 54), surface waste and plastic are collected, which are then it automatically collects through the spillway (pos. 16) to the place of the barge (pos. 55). All the details of the Cascade Hydroelectric Power Plant are additionally described in the Patent WO 2019/103634, which clarifies the rapid passage of the vessel (pos. 52) at the place of the locks (pos. 50) and (pos. 51), as well as the additional arrangement of the coast (pos. 53) for the needs of the theme and aqua park (pos. 56).

In this case, the displayed elevation of the bank (pos. 53) is 0.00 m, the spillway (pos. 16) on the fixed reinforced-concrete arch (pos. 9) is at −1.50 m, while the working position of the two barriers (pos. 43) is at −2.50 m. Thus, the slowness of water (pos. 17) is at an elevation of −2.50 m, while the water outlet is below the Hydroelectric Power Plant at an elevation of −5.50 m. The useful height difference of (pos. 17) water is 3 meters.

The expected mean annual flow is 5,600 m³/s, while the maximum recorded high-water flow is 11,700 m³/s. The turbine pipe is 10 m wide and 3.4 m high, with a cross-sectional area of 34 m². One Hydro Turbine has a water flow of approximately 100 m³/s, 56 of them have been installed. Two hydro turbines are paired with one machine room with a width of 25 m.

Engine rooms (pos. 32) are located under port (pos. 9), below the water level. Observing from the bank (pos. 53), one can see the elliptical arch (pos. 9), which visually connects the upper and lower water levels. The installed generator power in engine room (pos. 32) is 6 MW×28 positions=168 MW in total. Arch (pos. 9) is approximately 25 m long×28 positions=700 m.

The section of the river is 400 m wide. The length of the Hydroelectric Power Plant is 1,000 m. Pier (pos. 54) with a small lock (pos. 51) is 150 m long. Barrier (pos. 43) with lock (pos. 50) is 150 m long. Overflow (pos. 16) of water on auxiliary facilities is 300 m long×2 m high×6 m/s=3,600 m³/s.

The difference of additional water flow of 2,500 m³/s during extreme floods will overflow the total length of the Hydroelectric Power Plant of 1 km. With a water speed of 6 m/s, that's an additional rise in water level by 0.4 m. It remains as safety, 0.6 m of free space to the level of the bank (pos. 53).

Now the difference in the water level drop in the river bed is 8 m. Barrier (pos. 43) is installed with a water level difference of −2 m. A water level difference of 3 m is used at the Hydroelectric Power Plant. There remains a permanent raising of the downstream river of 3 m for the needs of constant river navigation.

In accordance with Patent WO 2019/103634, technical solutions have been developed for the simplicity and efficient application of the Cascade Hydroelectric Power Plant. Where the technical details and shortcomings were resolved, among others the following. The Hydroelectric Plant is built mainly of reinforced concrete, templated. The parts are installed separately, easily and changed after self-consumption. Noiseless operation of a large number of turbines at the larger Hydroelectric Power Plant was achieved. The Hydroelectric Power Plant does not retain sediment, it is a permanent place of installation. The tension and vibrations of the working parts have been solved. It is possible to return the blades to the initial position without resistance. 100% is controlled and uses the mean flow of water in the river at the place of operation of the turbines. The Hydropower Plant works smoothly even in conditions of surface ice. The engine room is under the water, from which the operation is controlled automatically in accordance with other Hydroelectric Plants.

When applying the structure for the use of tides, the basis of the setting from the Patent WO 2019/103634 with its extension is used. So, between the Hydro Wing and the bow there is a rubber membrane, through which the chains with paddles pass. Then the hydrofoil and the arch have a surface parallel to each other, slightly larger than the surface of the blade. With the engine, gear and reduction, the six blades rotate in the opposite direction to the action of the tide, when the energy of the tide is used. Hydro Turbines are arranged one on top of the other, as needed.

### METHOD OF INDUSTRIAL OR OTHER APPLICATION OF THE INVENTION

Production of electricity from lowland rivers, as well as from tides. In terms of river regulation, flood protection, melioration and natural irrigation of land at a distance of tens of kilometers from the coast have been achieved. Permanently fertile agricultural land is preserved against the meandering of the river and against coastal erosion. Efficient irrigation and cultivation of rice on large areas, when the soil is naturally drained of water for harvesting purposes. Urban development of the river with tourist and sports content. Safe, mapped and constant river navigation regardless of weather conditions. Construction of new profitable ports on the river, relief of classic transport. Improved living environment, safe fish spawning grounds. Self-cleaning of the river from waste and plastic, automatically without the consumption of additional energy. Using the river bed for water accumulation, stopping 100% of the flow in the river during the night for daily electricity production, which is not the case now. Planned extraction of gravel and sand as construction material below the surface of the water, economically useful and necessary for the maintenance of watercourses.

Position in Pictures

| | |
|---|---|
| (1) Water Level | (2) Water |
| (3) Air | (4) Retaining Wall |
| (5) The Bottom of The Riverbed | (6) Slab / Strip Foundation |
| (7) Threshold | (8) Hydro Wing |
| (9) Onion | (10) Grating |
| (11) Funnel | (12) Water Discharge |
| (13) Turbine Tube | (14) Water Flow Through the Turbine |
| (15) Turbine Blades | (16) Overflow of Water |
| (17) Water Height Difference | (18) Rotating Blade Bearing |
| (19) Blade Support Bearing | (20) Blade Position Bearing |
| (21) Blade Guide | (22) Bumper |
| (23) Rubber Bands | (24) Water Valve |
| (25) Sensors / Camera | (26) Groove on The Wall |
| (27) “U” Metal Profile | (28) Sprocket with Housing |
| (29) Multi-Row Stainless Steel Chain | (30) Chain Guide with Housing |
| (31) Roller With Casing | (32) Engine Room |
| (33) Engine Room Cover | (34) Seaming on The Engine Room Wall |
| (35) Transmission Of Mechanical Energy | (36) Drive Sprocket |
| (37) Drive Shaft | (38) Generator with Reducer |
| (39) Flywheel | (40) Brake on The Engine Room Wall |
| (41) Water Flow Regulator | (42) Vertical Water Inlet on The Grate |
| (43) Barrier | (44) Barrier Shaft |
| (45) Fish Ladder | (46) Blade Support |
| (47) Sealing Rubber on Blade | (48) Deposit Cleaner |
| (49) Stainless Steel Sheet | (50) Lock |
| (51) Small Lock | (52) Vessel |
| (53) River Bank / Promenade | (54) A Pier with A Lookout Point |
| (55) Waste Collection with A Barge | (56) Theme and Aqua Park |

1. The construction for the Cascade Hydroelectric Power Plant should contain:
a) the position of the threshold (7) resting on the base plate (6), at the bottom (5) of the river bed;
b) where the Hydro Wing (8), arch (9) with grid (10) are connected to two walls (4);
c) when the threshold (7), the lower part of the Hydro Wing (8) with two walls (4) forms the tube (13) of the turbine;
d) when the hydraulic wing (8) structurally forms the necessary height difference (17) of the water (2);
e) where the water overflow (16) is located on the upper part of the Hydro Wing (8) and port (9);
f) where the machine room (32) is located between two turbines, two opposite (4) walls, under the arch (9) with an entrance and exit at the place of the cover (33).

2. In accordance with patent claim 1, where the turbine blades (15) with chains (29) rotate on the surface of the Hydro Wing (8) supported by sprockets (28), guides (30) and rollers (31).

3. In accordance with patent claim 1, where the setting of the guides (21), strip (23) made of rubber, “U” profile (27), buffer (22), rubber on the blade enables noiseless and safe operation of the blades (15) turbines.

4. In accordance with patent claim 1, where the setting of the drive shaft (37) with the searing (34) in the wall (4), the drive sprocket (36) with the flywheel (39) enables stable production of electricity below the water level.

5. In accordance with patent claim 1, where a brake (40) is installed on the wall of the machine room (32) which uses a flywheel (39) as a braking disc, and which, through a coupled system and control, uses a vane (15) as valve (24) in the tube (13) of the turbine.

6. In accordance with patent claim 1, where the installation of grooves (26) on the walls (4) enables the place of a temporary constitution for the needs of the overhaul of the Hydroelectric Power Plant.

7. In accordance with patent claim 1, where the setting of an additional profile with a bearing, guides, supports (46) ensures stable operation of the blade (15) in the tube (13) of the turbine.

8. Where the Hydroelectric Plant is placed in the mother of the river with the shape of the Latin letter “S”, it is connected to the coast by barriers (43) that control high water (2), and where the entire length of the Hydroelectric Plant is used as an overflow (16) for flood protection.

9. Where the construction of the Cascade Hydroelectric Power Plant is adjusted for the needs of using tides and sections in the production of electricity.
